(19) United States
(12) Patent Application Publication
(10) Pub. No.: US 2026/0134607 A1
(43) Pub. Date: May 14, 2026

(54) TWO-DIMENSIONAL GAUSSIAN SPLATTING WITH TEXTURING FOR VIEW GENERATION IN COMPUTING SYSTEMS

(71) Applicant: DISNEY ENTERPRISES, INC., Burbank, CA (US)

(72) Inventors: Derek Edward BRADLEY, Zürich (CH); Sebastian Klaus WEISS, Zürich (CH)

(21) Appl. No.: 19/388,854

(22) Filed: Nov. 13, 2025

Related U.S. Application Data
(60) Provisional application No. 63/720,574, filed on Nov. 14, 2024.

(51) Int. Cl. G06T 15/04; G06T 15/06; G06T 15/20

(52) U.S. Cl. CPC G06T 15/04; G06T 15/06; G06T 15/205

(57) ABSTRACT

Embodiments of the present disclosure provide generating one or more views of a scene from an input depicting the scene. An example method includes decomposing an input image depicting a view of a scene into a plurality of two-dimensional Gaussian primitives. Each two-dimensional Gaussian primitive may be defined based on a center position and a local tangent plane. A respective color grid is defined for each respective two-dimensional Gaussian primitive of the plurality of two-dimensional Gaussian primitives based on a parameterization of the local tangent plane. Colors for the respective color grid associated with each respective two-dimensional Gaussian primitive are interpolated based on a scaling factor, the interpolated colors corresponding to a texture associated with the respective color grid. One or more views of the scene other than the depicted view are constructed based on the interpolated colors for each respective color grid associated with each respective two-dimensional Gaussian primitive.

### CROSS-REFERENCE TO RELATED APPLICATIONS

This application claims benefit of and priority to U.S. Provisional Patent Application Ser. No. 63/720,574, entitled “Two-Dimensional Gaussian Splatting With Textures,” filed Nov. 14, 2024, and assigned to the assignee hereof, the entire contents of which are hereby incorporated by reference.

### BACKGROUND

### Field of the Various Embodiments

Embodiments of the present disclosure relate generally to computer vision and machine learning, and more specifically to techniques for texture-preserving view generation in computer vision systems.

### Description of the Related Art

Reconstructing three-dimensional scenes from a collection of two-dimensional images allows for various computer vision tasks to be performed. For example, these tasks may include view synthesis, in which unseen views are generated from one or more known views of a scene, relighting, animation playback, animation retargeting, and the like. Scene reconstruction can be performed from one or more input views of the scene using three-dimensional Gaussian splatting techniques. In three-dimensional Gaussian splatting techniques, a scene may be represented as a collection of volumetric primitives that are positioned and oriented in a three-dimensional space and then rendered as two-dimensional splats to generate a screen. To improve the rendering of details in a scene generated using Gaussian splatting techniques, two-dimensional Gaussian splatting techniques can be used. In two-dimensional Gaussian splatting techniques, the volumetric primitives of three-dimensional Gaussian splatting are replaced with two-dimensional primitives (or disks). However, these techniques generate views of scenes that may lack textural detail, especially in areas with limited geometric detailing.

Thus, what is needed in the art are more effective techniques for generating visual representations of scenes in computer vision applications.

### SUMMARY

One embodiment of the present disclosure sets forth techniques for generating one or more views of a scene from an input depicting the scene. An example method includes decomposing an input image depicting a view of a scene into a plurality of two-dimensional Gaussian primitives. Each two-dimensional Gaussian primitive may be defined based on a center position and a local tangent plane. A respective color grid is defined for each respective two-dimensional Gaussian primitive of the plurality of two-dimensional Gaussian primitives based on a parameterization of the local tangent plane. Colors for the respective color grid associated with each respective two-dimensional Gaussian primitive are interpolated based on a scaling factor, the interpolated colors corresponding to a texture associated with the respective color grid. One or more views of the scene other than the depicted view are constructed based on the interpolated colors for each respective color grid associated with each respective two-dimensional Gaussian primitive.

One technical advantage of the disclosed techniques is that the disclosed techniques allow for the generation of views of a scene with improved visual acuity relative to existing techniques. Unlike techniques that assign a single color to each Gaussian primitive used in generating a view of a scene from input images, embodiments described herein define a grid of colors associated with a center point of each Gaussian primitive and interpolate the colors for each element (e.g., pixel) in the grid. By doing so, embodiments of the present disclosure allow for the generation of views of a scene that have improved texture fidelity relative to embodiments in which a single color is assigned to each Gaussian primitive. Further, embodiments presented herein may allow for the generation of views of a scene with improved texture fidelity for the same number of primitives as view generation using 2D Gaussian primitives with a single color or 3D Gaussian primitives.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 illustrates an example two-dimensional Gaussian billboard primitive in which a color grid is defined for generating a view of a scene with textural detail, according to some embodiments.

FIG. 3 illustrates example Gaussian billboard primitives, according to some embodiments.

FIG. 4 illustrates example operations for generating one or more views of a scene based on Gaussian primitives generated for input images depicting another view of the scene and a color grid defined for the Gaussian primitives, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

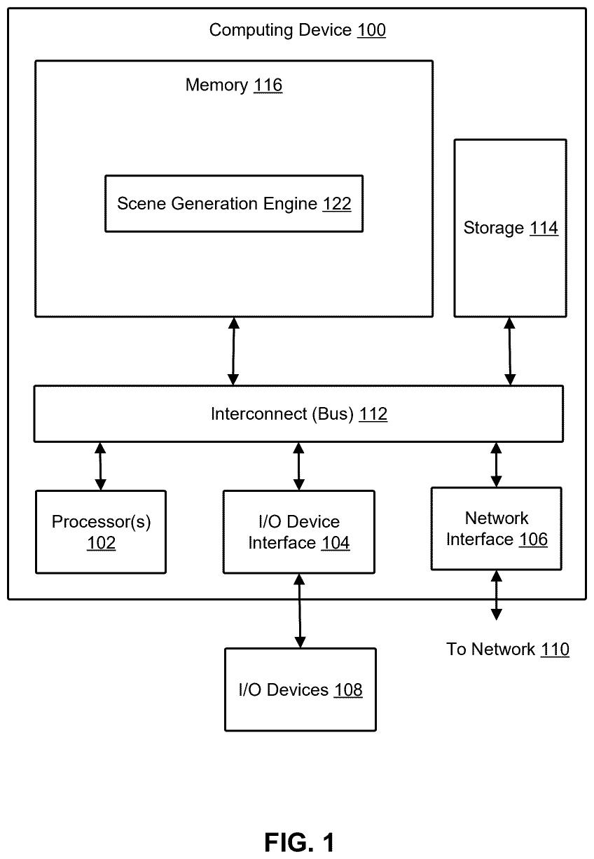

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a scene generation engine 122 that resides in a memory 116.

It is noted that the computing device described herein is illustrative and that any other technically feasible configurations fall within the scope of the present disclosure. For example, multiple instances of scene generation engine 122 could execute on a set of nodes in a distributed and/or cloud computing system to implement the functionality of computing device 100. In another example, scene generation engine 122 could execute on various sets of hardware, types of devices, or environments to adapt scene generation engine 122 to different use cases or applications. In a third example, scene generation engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Scene generation engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including scene generation engine 122.

Example Two-Dimensional Gaussian Splatting with Texturing for View Generation

In computer vision tasks, as discussed, Gaussian splatting techniques allow for the generation of views of a scene based on Gaussian primitives derived from one or more images of a scene. In using Gaussian primitives to generate a view of a scene from images of the scene, a rendering engine can represent a scene as a collection of overlapping, or partially overlapping, Gaussian primitives. In three-dimensional Gaussian splatting, a primitive k may be defined by a location in a three-dimensional space pₖ, a covariance matrix Σₓ parameterized by a scale factor sₖ and an opacity αₖ. An oriented and colored ellipsoid representation can be transformed into a three-dimensional Gaussian primitive by multiplying the opacity α with a three-dimensional Gaussian distribution

$$𝒢 ( p ) = exp ( - \frac{1}{2} {( p - {p}_{k} )}^{T} {\sum }^{- 1} ( p - {p}_{k} ) ) .$$

The perspective projection of the three-dimensional Gaussian distribution can be approximated to produce a two-dimensional Gaussian distribution [symbol] ^{2D} in a screen space, and the three-dimensional splats intersecting a ray of a pixel x can be blended together using front-to-back alpha compositing according to the equation:

$$c ( x ) = {\sum }_{k = 1}^{K} {c}_{k} {α}_{k} {𝒢}_{k}^{2 D} ( x ) {\prod }_{j = 1}^{k - 1} ( 1 - {α}_{j} {𝒢}_{j}^{2 D} ( x ) )$$

Two-dimensional Gaussian splatting techniques simplify the view generation techniques using three-dimensional Gaussian splatting techniques discussed above by representing a scene as a collection of oriented, flat, two-dimensional primitives. The geometry of a two-dimensional Gaussian primitive may be defined by a center position pₖ∈ [symbol] ³, orthogonal tangent vectors t_{u,k}, t_{v,k}∈ [symbol] ³ derived from a rotation quaternion, and a two-dimensional scaling vector S=(sᵤ, s_{y})∈ [symbol] ². The orthogonal tangent vectors t_{u,k}, t_{v,k} represent vectors on the u-axis and the v axis, respectively, which may be a local x axis and y axis, rotated according to a rotation of the two-dimensional Gaussian primitive. The center position, tangent vectors, and scaling vector may define a local tangent plane associated with a two-dimensional primitive k parameterized by u=(u, v) according to the equation:

$$P ( u ) = {p}_{k} + {s}_{u} {t}_{u , k} u + {s}_{v} {t}_{v , k} v$$

The resulting two-dimensional Gaussian distribution for modulating the opacity of the ordered set of primitives may be defined in the uv-space according to the Gaussian distribution:

$${𝒢}_{u} = exp ( - \frac{1}{2} ( {u}^{2} + {v}^{2} ) )$$

In two-dimensional Gaussian splatting, each two-dimensional primitive is rendered with a constant color cₖ across the entirety of the two-dimensional plane over which the two-dimensional primitive spans. In doing so, geometry and textural information may be tightly coupled in the same representation. Further, the amount of geometric and textural data may be limited by the same quantity, such as the number of splats overlapping at each pixel or region of pixels in an image representing a view of a scene. However, in many scenes, the amount of textural information included in the scene may be higher than the amount of geometric information in the scene.

To account for the difference in the amount of textural information and geometric information in a scene, embodiments of the present disclosure adapt textured billboard techniques to allow each two-dimensional Gaussian primitive to include a spatially-varying color representation. In computer graphics application, a billboard may be a textured rectangle that can be transformed such that the billboard appears parallel to a viewing plane. By doing so, each two-dimensional Gaussian primitive can embed more color information than a Gaussian primitive that is rendered with a constant color cₖ across the entirety of the two-dimensional plane over which the two-dimensional primitive spans.

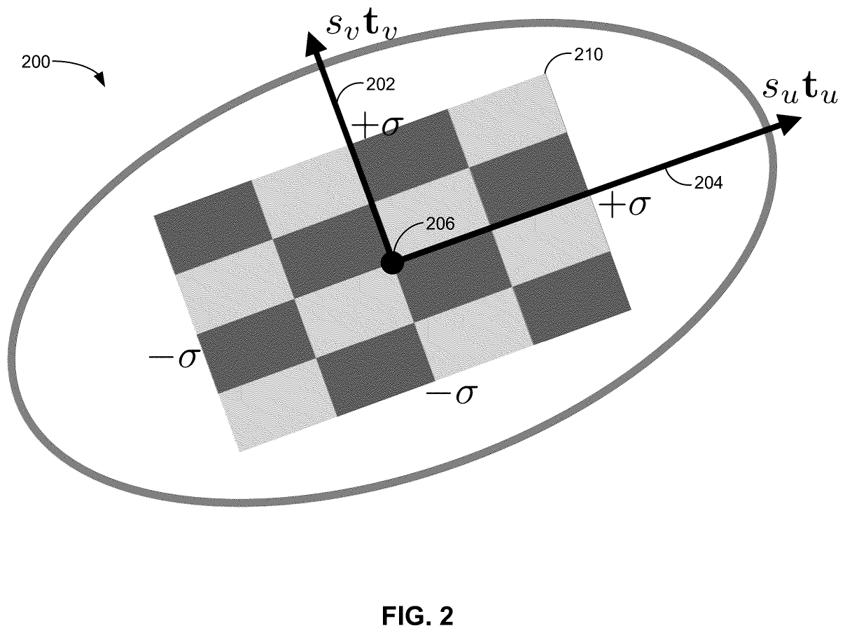

FIG. 2 illustrates an example two-dimensional Gaussian billboard primitive 200 in which a color grid is defined for generating a view of a scene with textural detail, according to some embodiments.

The two-dimensional Gaussian billboard primitive 200 may be defined as an ellipsoid on a two-dimensional u-v plane (which may be an x-y plane local to the two-dimensional Gaussian billboard primitive 200) with a center point 206. To generate a region of the two-dimensional Gaussian billboard primitive 200 with a color grid 210 in which texture can be defined, scene generation engine 122 can define the color grid 210 based on a spatial extent σ on the u-v plane within the two-dimensional Gaussian billboard primitive 200. σ∈ [symbol] ⁺ may define the spatial extent, and the color grid 210 may span [−σ, +σ] on both the u axis 204 and the v axis 2-2 in the two-dimensional Gaussian billboard primitive 200. Scene generation engine 122 can then define the colors of the pixels in the color grid 210, and thus the color of the two-dimensional Gaussian billboard primitive 200, based on bilinear interpolation, according to the equation:

$${c ( u , v )}_{k} = bilinear ( {C}_{k} , \frac{u}{σ} , \frac{v}{σ} )$$

In the above equation, bilinear(C, x, y) represents a bilinear interpolation of a single pixel with a defined color, normalized coordinates x, y∈[−1, +1], into a grid C with shape N×N, where N∈ [symbol] represents the resolution of the color grid 210. Because the color grid is defined in the uv-parameterization of the two-dimensional Gaussian primitive 200, the color grid scales with S and rotates with t_{u,k}, t_{v,k}.

In some embodiments, scene generation engine 122 uses one or more rendering or rasterization techniques to generate images depicting one or more views of a scene depicted in one or more input images (e.g., depicting the scene from one or more different perspectives). In such a case, scene generation engine 122 can optimize a scene representation using backward rasterization techniques in which the input images are transformed into an object space in a backward rasterization process. The forward process implemented by the rasterization technique can transform information in the object space into a two-dimensional raster image space. In the backward rasterization process, scene generation engine 122 can obtain the primitives associated with an input image, and for each pixel or range of pixels in the input image define a transmittance T, the adjoint of the output color, ĉ_{acc}, and an initial output color c_{acc}=(0,0,0) in the red, green, and blue (RGB) color space. For each Gaussian primitive k within a sorted range of primitives, which may be primitives sorted by the depth of the center location of the Gaussian primitives, a scene generation engine 122 intersects a primitive k with a view ray on the u and v axes. Scene generation engine 122 computes an opacity associated with a Gaussian primitive k, according to the equation

$$α = {α}_{k} * exp ( - \frac{{u}^{2} + {v}^{2}}{2} )$$

and evaluates the color c associated with the Gaussian primitive according to a bilinear interpolation, as discussed above.

In the training process, represented by the backward rasterization process, scene generation engine 122 further computes adjoints of color, alpha, Gaussian opacity, and ray intersection. Each of these adjoints may be gradients that represent how pixel values in a resulting image generated by the rasterization technique would change with a perturbation of one or more of the parameters of color, alpha, Gaussian opacity, or ray intersection. An adjoint of color with visibility may be defined as ĉₖ=(α*\T)ĉ_{acc}. The color-adjoint Ĉ, û, \hat{v} may be calculated as an adjoint bilinear interpolation of the parameters u, v, Cₖ, and ĉₖ. The color-adjoint may be a gradient of an image or portion thereof with respect to the color of pixels in the image. Scene generation engine 122 can further calculate the adjoint of alpha, \hat{α}, based on the color c, the adjoint of Gaussian opacity, û, \hat{v}, and the adjoint of ray intersection, \hat{p}, [symbol] , [symbol] , ŝᵤ, ŝᵥ. These adjoints may be accumulated into a global memory, with the color of each Gaussian primitive extended to a grid instead of being defined as a single color for each gaussian primitive.

During inferencing operations, scene generation engine 122 computes the pixel location pₓ, p_{y} of a pixel in an. Using the computed pixel location, scene generation engine 122 decomposes an input image into a plurality of Gaussian primitives k, with each Gaussian primitive k having a positional value, rotational value along the u-v axis, a scale on the u and v axes, and a color grid Cₖ including a plurality of pixels. A forward pass executed by scene generation engine 122 proceeds with initializing transmittance T to 1 and the accumulated color c_{acc}=(0,0,0).

For each Gaussian primitive k in a sorted range of Gaussian primitives, where the sorted range is defined based on a depth metric associated with the center point of each Gaussian primitive, scene generation engine 122 intersects the primitive with a view ray to obtain a location at which the ray intersects the Gaussian primitive on the u and v axes (which, as discussed, may be a local x-y axis in the Gaussian primitive k). Using the location at which the ray intersects the Gaussian primitive, scene generation engine 122 evaluates the color at a local color grid using bilinear interpolation techniques discussed above and calculates an opacity of the color according to the equation

$$α = {α}_{k} * exp ( - \frac{{u}^{2} + {v}^{2}}{2} ) .$$

accumulated color for the color grid, c_{acc} may be calculated according to the equation c_{acc}+=cαT, and transmittance T may be reduced according to the equation T*=(1−α). In reducing the transmittance T, scene generation engine 122 may make various adjustments for each Gaussian primitive k in the sorted list of Gaussian primitives such that primitives in the sorted range influence the color associated with a location in the resulting image according to the order in which Gaussian primitives are ordered in the sorted list. That is, Gaussian primitives having a higher rank in the sorted list may have a greater influence on the resulting color at a location in a rendered view of the scene than Gaussian primitives having lower ranks in the sorted list.

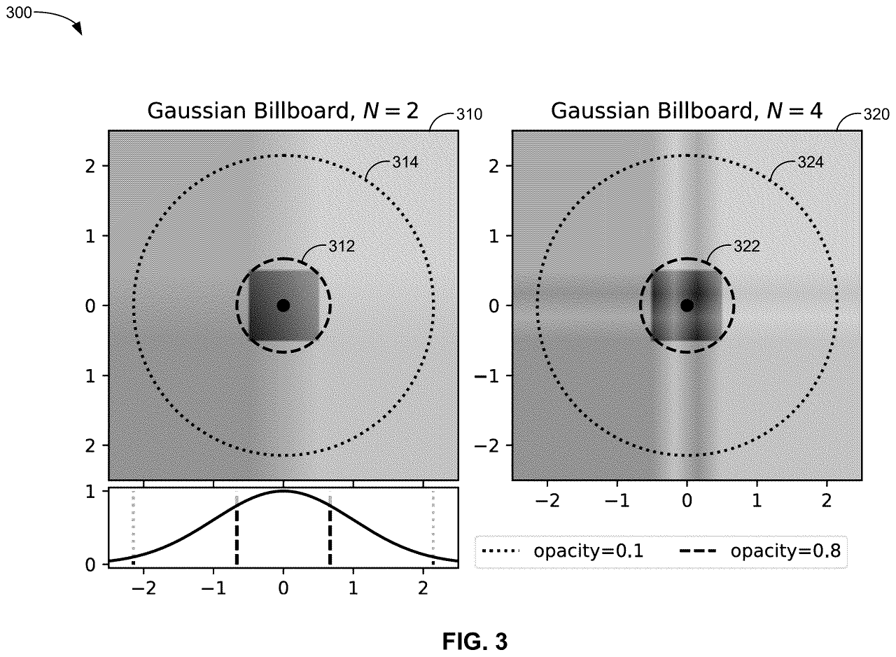

FIG. 3 illustrates examples 300 of Gaussian billboard primitives, according to some embodiments.

Gaussian billboard primitive 310 represents a primitive generated with a color grid of size N×N, N=2, and Gaussian billboard primitive 320 represents a primitive generated with a color grid of N×N, N=4. Within the circles 312, 322, associated with the area of [−σ+σ]², the borders of the color grid may be defined based on border-clamping the uv-values in the bilinear interpolation function as discussed above. Resultingly, the infinite nature of a Gaussian primitive may be clamped to a size of the color grid within circle 312, 322. Circles 312, 322 may represent an area within an isoline of 0.8 opacity in which a color (texture) grid exists, while circles 314, 324 may represent an area defined by the isoline of 0.1 opacity.

In some embodiments, σ may be selected such that the color grid is clamped to minimize, or at least reduce, the area over which clamping occurs. In the example illustrated in FIG. 3, σ may be selected to minimize the area of clamping that occurs at the isoline of 0.1. However, it should be recognized that any value of σ may be selected, and the selection of σ may influence the expanse over which a color (texture) grid spans and the area over which border clamping occurs. Generally, smaller values of σ may indicate that texture details are concentrated in the center of a Gaussian primitive, while larger values of σ may indicate that texture details are less concentrated at the center of the Gaussian primitive.

In some embodiments, for a value of σ=0.5, the size of the color grid N may influence the amount of detail recovered in a view of a scene generated by scene generation engine 122. With N=1 (i.e., a uniform color associated with a Gaussian primitive), it may be seen that details in the view generated by scene generation engine 122 are blurred or approximated with elongated splats. Increased values of N (i.e., the use of a grid in which color within a Gaussian primitive is interpolated over a multipixel grid and is not generated based on single color representations) may result in increases in the amount of detail in a generated view of a scene. For example, textural detail of paint applied to a surface or textural details of plants and buildings may improve with increased values of N.

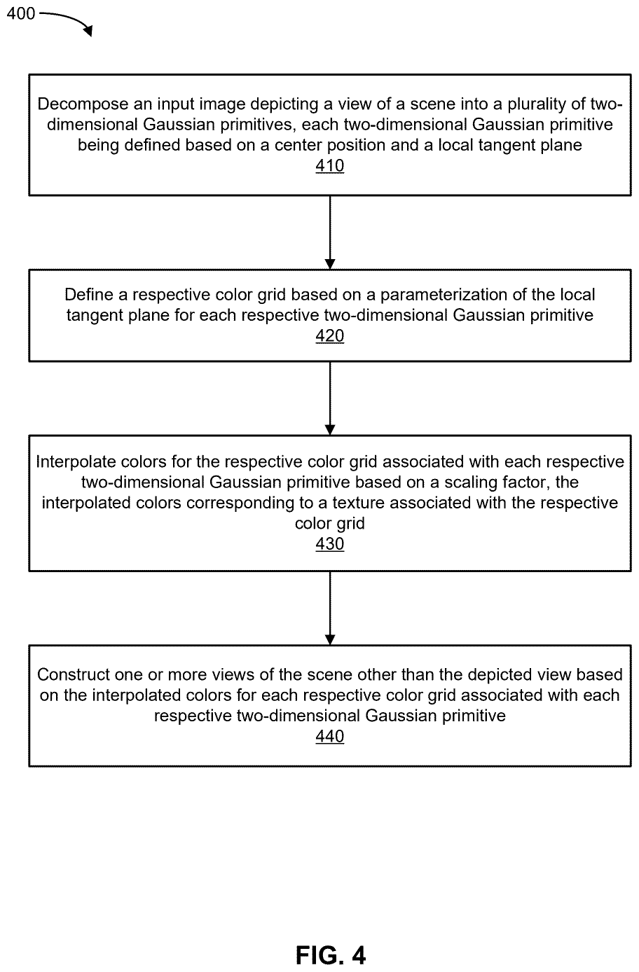

FIG. 4 illustrates example operations 400 for generating one or more views of a scene based on Gaussian primitives generated for input images depicting another view of the scene and a color grid defined for the Gaussian primitives, according to some embodiments. Operations 400 may be performed, for example, by scene generation engine 122 illustrated in FIG. 1.

As illustrated, operations 400 begin at block 410, where scene generation engine 122 decomposes an input image depicting a view of a scene into a plurality of two-dimensional Gaussian primitives. Each two-dimensional Gaussian primitive may be defined based on a center position and a local tangent plane. The local tangent plane may be a u-v tangent plane, with u and v corresponding to an x and y axis on local tangent plane associated with the two-dimensional Gaussian primitive.

In some embodiments, decomposing the input image comprises generating the plurality of two-dimensional Gaussian primitives based on ray tracing at one or more pixels of the input image. Rays may be traced from one or more positions in a real space. These positions may indicate a perspective in which the constructed views of the scene are to be constructed.

At block 420, scene generation engine 122 defines a respective color grid based on a parameterization of the local tangent plane for each respective two-dimensional Gaussian primitive of the plurality of two-dimensional Gaussian primitives. The color grid may be defined based on a spatial extent σ∈ [symbol] ⁺ and a grid with shape N×N evaluated at a defined location within a specific two-dimensional Gaussian primitive. That is, in some embodiments, each respective color grid may be defined as a square grid with multiple pixels.

At block 430, scene generation engine 122 interpolates \colors for the respective color grid associated with each respective two-dimensional Gaussian primitive based on a scaling factor. The interpolated colors may correspond to a texture associated with the respective color grid.

In some embodiments, scene generation engine 122 interpolates colors for the respective color grid associated with each respective two-dimensional Gaussian primitive by calculating a color based on a bilinear interpolation of a pixel into a grid of pixels associated with the respective color grid. The bilinear interpolation of the pixel into a grid of pixels may be based on the location on a uv plane in the two-dimensional Gaussian primitive through which a ray passes. The interpolated colors may be defined in a uv parameterization of the two-dimensional Gaussian primitive and may scale with a two-dimensional scaling vector S and may rotate with t_{u,k}, t_{v,k}.

In some embodiments, the grid of pixels may be defined on one or more axes between a lower spatial bound and an upper spatial bound on the one or more axes. The spatial bound may be based on a spatial extent σ and isolines at an opacity value defined a priori or dynamically that clamps uv-values in the interpolation function and causes the color grid (corresponding to texture in an image) to reside within a high opacity region (e.g., based on the isoline of 0.8 opacity).

At block 440, scene generation engine 122 constructs one or more views of the scene other than the depicted view based on the interpolated colors for each respective color grid associated with each respective two-dimensional Gaussian primitive.

In some embodiments, scene generation engine 122 constructs the one or more views of the scene based on blending the interpolated colors for a set of color grids from one or more two-dimensional Gaussian primitives into a pixel value at a location in the scene. The blending may be based on a transmittance, which may decrease with each Gaussian primitive blended into a final pixel value (or set of pixel values) associated with a location in the input image, and a blending factor or transparency factor α, indicating a level of transparency associated with each Gaussian primitive. In doing so, and in conjunction with a sorted list of two-dimensional Gaussian primitives, primitives that are at the top of the sorted list (e.g., primitives with an intersecting position that has a higher depth value) may have larger impacts on the resulting color of a pixel (or pixels) than primitives that are at the bottom of the sorted list.

In some embodiments, the set of color grids comprises a depth-sorted set of grids associated with the location in the scene. The set of color grids may be sorted based on a depth of a center position of two-dimensional Gaussian primitives associated with the set of color grids. As discussed the resulting set of color grids may be a sorted list based on a distance of each Gaussian primitive (and corresponding color grid) relative to a particular view point for which the constructed one or more views of the scene are generated.

The techniques discussed herein generally allow computer vision systems to efficiently generate detailed views of scenes from an input scene. By using a color grid within two-dimensional Gaussian primitives over which color is interpolated, embodiments of the present disclosure may decouple geometry from texture information. Texture information, which may be more plentiful than geometric information, may be represented by differences in the colors representing a color grid. When grids over a plurality of Gaussian primitives are aggregated, the resulting image may include higher amounts of textural detail relative to techniques in which a single color is used to represent the data within a Gaussian primitive. Further, the techniques described herein may allow for increased detail generation in synthetically generated views of scenes generated by a generative artificial intelligence model or in other computer vision tasks for the same number of primitives used in generating these views. These technical advantages provide one or more improvements over prior approaches.

### Example Clauses

Various embodiments of the present disclosure are described in the following numbered clauses:

1. In some embodiments, a computer-implemented method for generating views of a scene using Gaussian primitives, the computer-implemented method comprises decomposing an input image depicting a view of a scene into a plurality of two-dimensional Gaussian primitives, each two-dimensional Gaussian primitive being defined based on a center position and a local tangent plane; defining a respective color grid based on a parameterization of the local tangent plane for each respective two-dimensional Gaussian primitive of the plurality of two-dimensional Gaussian primitives; interpolating colors for the respective color grid associated with each respective two-dimensional Gaussian primitive based on a scaling factor, the interpolated colors corresponding to a texture associated with the respective color grid; and constructing one or more views of the scene other than the depicted view based on the interpolated colors for each respective color grid associated with each respective two-dimensional Gaussian primitive.

2. The method of clause 1, wherein each respective color grid comprises a square grid with multiple pixels.

3. The method of any of clauses 1 or 2, wherein interpolating colors for the respective color grid associated with each respective two-dimensional Gaussian primitive comprises calculating a color based on a bilinear interpolation of a pixel into a grid of pixels associated with the respective color grid.

4. The method of clause 3, wherein the grid of pixels is defined on one or more axes between a lower spatial bound and an upper spatial bound on the one or more axes.

5. The method of any of clauses 1 through 4, wherein constructing the one or more views of the scene comprises blending the interpolated colors for a set of color grids from one or more two-dimensional Gaussian primitives into a pixel value at a location in the scene.

6. The method of clause 5, wherein the set of color grids comprises a depth-sorted set of grids associated with the location in the scene, the set of color grids being sorted based on a depth of a center position of two-dimensional Gaussian primitives associated with the set of color grids.

7. The method of any of clauses 1 through 6, wherein decomposing the input image comprises generating the plurality of two-dimensional Gaussian primitives based on ray tracing at one or more pixels of the input image.

8. A processing system, comprising: at least one memory having executable instructions thereon; and one or more processors configured to execute the executable instructions to cause the processing system to perform the method of any of clauses 1 through 7.

9. A processing system, comprising means for performing the method of any of clauses 1 through 7.

10. A non-transitory computer-readable medium having executable instructions stored thereon which, when processed by one or more processors, causes the one or more processors to perform the method of any of clauses 1 through 7.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A processor-implemented method, comprising:
decomposing an input image depicting a view of a scene into a plurality of two-dimensional Gaussian primitives, each two-dimensional Gaussian primitive being defined based on a center position and a local tangent plane;
defining a respective color grid based on a parameterization of the local tangent plane for each respective two-dimensional Gaussian primitive of the plurality of two-dimensional Gaussian primitives;
interpolating colors for the respective color grid associated with each respective two-dimensional Gaussian primitive based on a scaling factor, the interpolated colors corresponding to a texture associated with the respective color grid; and
constructing one or more views of the scene other than the depicted view based on the interpolated colors for each respective color grid associated with each respective two-dimensional Gaussian primitive.

2. The method of claim 1, wherein each respective color grid comprises a square grid with multiple pixels.

3. The method of claim 1, wherein interpolating colors for the respective color grid associated with each respective two-dimensional Gaussian primitive comprises calculating a color based on a bilinear interpolation of a pixel into a grid of pixels associated with the respective color grid.

4. The method of claim 3, wherein the grid of pixels is defined on one or more axes between a lower spatial bound and an upper spatial bound on the one or more axes.

5. The method of claim 1, wherein constructing the one or more views of the scene comprises blending the interpolated colors for a set of color grids from one or more two-dimensional Gaussian primitives into a pixel value at a location in the scene.

6. The method of claim 5, wherein the set of color grids comprises a depth-sorted set of grids associated with the location in the scene, the set of color grids being sorted based on a depth of a center position of two-dimensional Gaussian primitives associated with the set of color grids.

7. The method of claim 1, wherein decomposing the input image comprises generating the plurality of two-dimensional Gaussian primitives based on ray tracing at one or more pixels of the input image.

8. A processing system, comprising:
at least one memory having executable instructions stored thereon; and
one or more processors configured to execute the executable instructions to cause the processing system to:
decompose an input image depicting a view of a scene into a plurality of two-dimensional Gaussian primitives, each two-dimensional Gaussian primitive being defined based on a center position and a local tangent plane;
define a respective color grid based on a parameterization of the local tangent plane for each respective two-dimensional Gaussian primitive of the plurality of two-dimensional Gaussian primitives;
interpolate colors for the respective color grid associated with each respective two-dimensional Gaussian primitive based on a scaling factor, the interpolated colors corresponding to a texture associated with the respective color grid; and
construct one or more views of the scene other than the depicted view based on the interpolated colors for each respective color grid associated with each respective two-dimensional Gaussian primitive.

9. The processing system of claim 8, wherein each respective color grid comprises a square grid with multiple pixels.

10. The processing system of claim 8, wherein to interpolate colors for the respective color grid associated with each respective two-dimensional Gaussian primitive, the one or more processors are configured to cause the processing system to calculate a color based on a bilinear interpolation of a pixel into a grid of pixels associated with the respective color grid.

11. The processing system of claim 10, wherein the grid of pixels is defined on one or more axes between a lower spatial bound and an upper spatial bound on the one or more axes.

12. The processing system of claim 8, wherein to construct the one or more views of the scene, the one or more processors are configured to cause the processing system to blend the interpolated colors for a set of color grids from one or more two-dimensional Gaussian primitives into a pixel value at a location in the scene.

13. The processing system of claim 12, wherein the set of color grids comprises a depth-sorted set of grids associated with the location in the scene, the set of color grids being sorted based on a depth of a center position of two-dimensional Gaussian primitives associated with the set of color grids.

14. The processing system of claim 8, wherein to decompose the input image, the one or more processors are configured to cause the processing system to generate the plurality of two-dimensional Gaussian primitives based on ray tracing at one or more pixels of the input image.

15. A non-transitory computer readable medium having executable instructions stored thereon which, when executed by one or more processors, performs an operation comprising:
decomposing an input image depicting a view of a scene into a plurality of two-dimensional Gaussian primitives, each two-dimensional Gaussian primitive being defined based on a center position and a local tangent plane;
defining a respective color grid based on a parameterization of the local tangent plane for each respective two-dimensional Gaussian primitive of the plurality of two-dimensional Gaussian primitives;
interpolating colors for the respective color grid associated with each respective two-dimensional Gaussian primitive based on a scaling factor, the interpolated colors corresponding to a texture associated with the respective color grid; and
constructing one or more views of the scene other than the depicted view based on the interpolated colors for each respective color grid associated with each respective two-dimensional Gaussian primitive.

16. The computer-readable medium of claim 15, wherein interpolating colors for the respective color grid associated with each respective two-dimensional Gaussian primitive comprises calculating a color based on a bilinear interpolation of a pixel into a grid of pixels associated with the respective color grid.

17. The computer-readable medium of claim 16, wherein the grid of pixels is defined on one or more axes between a lower spatial bound and an upper spatial bound on the one or more axes.

18. The computer-readable medium of claim 15, wherein constructing the one or more views of the scene comprises blending the interpolated colors for a set of color grids from one or more two-dimensional Gaussian primitives into a pixel value at a location in the scene.

19. The computer-readable medium of claim 18, wherein the set of color grids comprises a depth-sorted set of grids associated with the location in the scene, the set of color grids being sorted based on a depth of a center position of two-dimensional Gaussian primitives associated with the set of color grids.

20. The computer-readable medium of claim 15, wherein decomposing the input image comprises generating the plurality of two-dimensional Gaussian primitives based on ray tracing at one or more pixels of the input image.
